(19) United States
(12) Patent Application Publication
(10) Pub. No.: US 2022/0380518 A1
(43) Pub. Date: Dec. 1, 2022

(54) PROCESS FOR CONTINUOUS PRODUCTION OF THERMOPLASTIC POLYURETHANE

(71) Applicant: Covestro Intellectual Property GmbH & Co. KG, Leverkusen (DE)

(72) Inventors: Thomas KOENIG, Leverkusen (DE); Dirk ACHTEN, Leverkusen (DE); Bernd GARSKA, Köln (DE); Rainer BELLINGHAUSEN, Odenthal (DE); Claudia HOUBEN, Heinsberg (DE); Stephan SCHUBERT, Leverkusen (DE); Mathias MATNER, Neuss (DE)

(21) Appl. No.: 17/782,311

(22) PCT Filed: Dec. 10, 2020
(86) PCT No.: PCT/EP2020/085517

§ 371 Date: Jun. 3, 2022

(30) Foreign Application Priority Data
Dec. 17, 2019 (EP) 19216816.9

(51) Int. Cl. C08G 18/73; C08G 18/32; C08G 18/10

(52) U.S. Cl. CPC C08G 18/73; C08G 18/3206; C08G 18/10

(57) ABSTRACT

The present invention relates to a process for continuous production of thermoplastic polyurethane by reacting the components (A) one or more cycloaliphatic, aliphatic and/or araliphatic polyisocyanates and (B) one or more cycloaliphatic, aliphatic and/or araliphatic polyols, wherein the entirety of component (B) has a hydroxyl number of 600 mg KOH/g to 1830 mg KOH/g as determined according to DIN EN ISO 4629-2:2016. The process comprises the process steps of: a) preparing a mixture of a portion of component (A), a portion of or the entirety of component (B) and optionally a portion or the entirety of component (C), where in process step a) there is a molar ratio of component (A) to component (B) in the range from 0.6:1.0 to 0.95:1.0; b) mixing the mixture prepared in process step a) with an outgoing oligomerisate substream obtained from process step e); c) reacting the mixture from process step b); d) dividing the reaction mixture obtained in step c) into two outgoing substreams; e) recycling one outgoing substream from process step d) as an incoming substream for the mixture in process step b); f) mixing the remainder of component (A) and where present the remainder of components (B) and (C) with the remaining outgoing substream of process step d); and g) reacting the mixture obtained in process step f) to obtain a thermoplastic polyurethane. The invention further relates to thermoplastic polyurethane obtainable or obtained by the process of the invention, and also to a composition containing the thermoplastic polyurethane according to the invention and to the use thereof.

The present invention relates to a process for continuous production of thermoplastic polyurethane by reaction of components (A) one or more cycloaliphatic, aliphatic and/or araliphatic polyisocyanates and (B) one or more cycloaliphatic, aliphatic and/or araliphatic polyols, wherein the total amount of component (B) has a hydroxyl number of 600 mg KOH/g to 1830 mg KOH/g, determined in accordance with DIN EN ISO 4629-2:2016. The process comprises the process steps of: a) producing a mixture of a partial amount of component (A), a partial amount or the total amount of component (B) and optionally a partial amount or the total amount of component (C), wherein a molar ratio of component (A) to component (B) in process step a) is in the range from 0.6:1.0 to 0.95:1.0; b) mixing the mixture produced in process step a) with an oligomer output substream obtained from process step e); c) reacting the mixture from process step b); d) dividing the reaction mixture obtained in step c) into two output substreams; e) recycling an output substream from process step d) as an input substream for the mixing in process step b); f) mixing the remainder of component (A) and optionally the remainder of components (B) and (C) with the remaining output substream of process step d); and g) reacting to completion the mixture obtained in process step f) to obtain a thermoplastic polyurethane. The invention further relates to thermoplastic polyurethane obtainable or obtained by the process according to the invention and also to a composition containing the thermoplastic polyurethane according to the invention and to the use thereof.

Owing to their excellent physical properties, polyurethanes and especially thermoplastic polyurethanes have been used for a wide variety of different end uses for many years. In spite of the broad usability of polyurethanes, there are fields of application in which other plastics, for example polyamide plastics, are used because there are no polyurethanes having suitable physical properties available or these can be provided only with difficulty. Polyurethanes formed from short-chain diols and short-chain polyisocyanates have useful properties. A problem is that the high density of reactive groups means that the polyaddition of short-chain aliphatic diols with aliphatic polyisocyanates has a high heat/enthalpy of reaction that, if inadequately dissipated, results in damage, for example through discoloration, up to and including reformation of the monomers and destruction (ashing) of the polyurethane.

In industrial practice, preference is given to continuous production processes, since they make it easier to scale up production and allow greater amounts to be produced with constant quality.

The production of pellets from thermoplastics after a batchwise process results in the need to keep the fusible polymer at high temperature until the batch vessel is empty. For thermally sensitive products, this results in a profile of product properties that changes continuously over the pelletization process/pelletization time.

It is also difficult to impossible to apply process procedures from batchwise processes to continuous processes. Particular attention from a process engineering point of view is paid to the controlled removal of the heat of reaction released, which means that reactions with high exothermicity can be handled only with difficulty.

The use of solvents is likewise disadvantageous, since residual solvents remaining in the product may be released into its surroundings, causing unwanted properties such as odour, toxicity and/or a deterioration in mechanical properties. The complete removal of residual solvents from a polymer is intrinsically associated with an increase in technical complexity and in energy consumption.

DE 10 2011 085 944 A1 describes a process for producing a low-melting-point thermoplastic polyurethane in a loop reactor. The high reaction temperatures needed for the process promote the formation of allophanates and make it difficult or impossible to dissipate the heat evolved in reactions that are highly exothermic.

A process for producing polyurethane is disclosed for example in WO01/14441. This discloses a process for producing NCO-, NH- or OH-terminated polyurethanes in a static mixer. Key to this process is that the temperature during the reaction of the components is controlled adiabatically and/or that the static mixer is trace heated, consequently it is suitable only for processes that are endothermic or have only low exothermicity. The process is unsuitable for the reaction of components having a high enthalpy of reaction, i.e. components that react together strongly exothermically.

EP0519734 discloses a urethanization reaction process in which a polyol mixture comprising at least a long-chain polyol having a maximum hydroxyl number of 10 mg/g KOH is reacted with a polyisocyanate component to form a urethane-modified resin. The reaction mixture undergoes reaction in a static mixer at temperatures of 90° C. to 200° C. The low density of functional groups means that an input of energy is necessary here too.

A disadvantage of the processes described above is that they are suitable primarily for reactions that are either endothermic or have only a low heat of reaction and therefore require a constant input of heat or must be controlled adiabatically. In systems that have a high exothermicity of reaction (≤−350 kJ/kg), the adiabatic temperature rise is problematic. Starting from monomers at a temperature sufficient for uncatalyzed initiation of the reaction (>50° C.), the temperature of the reaction products would rise to well above 300° C. in adiabatic mode. The production and processing of polyurethanes at temperatures of >200° C. over longer periods is problematic on account of a multitude of thermal side reactions. A temperature of 300° C. is moreover above the ceiling temperature of the polyurethane bond. The ceiling temperature is defined as the temperature at which depolymerization is in equilibrium with polymerization.

It was accordingly an object of the present invention to provide a continuous and flexible process for producing polyurethane that allows the performance, on an industrial scale, of a polyaddition reaction having high negative enthalpy of reaction per kg of reaction mass.

This object is achieved by a process

for continuous production of thermoplastic polyurethane by reaction of components

(A) one or more cycloaliphatic, aliphatic and/or araliphatic polyisocyanates,

(B) one or more cycloaliphatic, aliphatic and/or araliphatic polyols, wherein the total amount of component (B) has a hydroxyl number of 600 mg KOH/g to 1830 mg KOH/g, determined in accordance with DIN EN ISO 4629-2:2016,

(C) optionally in the presence of one or more catalysts and/or one or more additives, characterized in that the process comprises the steps of:

a) producing a mixture of a partial amount of component (A), a partial amount or the total amount of component (B) and optionally a partial amount or the total amount of component (C), wherein a molar ratio of component (A) to component (B) in process step a) is in the range from 0.6:1.0 to 0.95:1.0;

b) mixing the mixture produced in process step a) with a prepolymer output substream obtained from process step e);

c) reacting the mixture from process step b);

d) dividing the reaction mixture obtained in step c) into two output substreams;

e) recycling an output substream from process step d) as an input substream for the mixture in process step b);

f) mixing the remainder of component (A) and optionally the remainder of components (B) and (C) with the remaining output substream of process step d); and

g) reacting to completion the mixture obtained in process step f) to obtain a thermoplastic polyurethane.

Advantageous developments are specified in the dependent claims. They may be combined as desired unless the opposite is clear from the context.

It has been found that, surprisingly, when performing the process according to the invention the temperature of the reaction mass may be very well controlled, thus avoiding heat related damage, for example speckling or discoloration in the polyurethane product. The good temperature control likewise allows side reactions to be controlled and optionally prevented or favoured. Close monitoring of the allophanate content for example is conceivable. Without wishing to be bound to a particular theory the advantages according to the invention are achieved through controlled reaction of the monomers in homogeneous admixture with the prepolymers which are recycled in a loop in the context of the process. In addition, it is thought by the applicants that the final chain extending also contributes to positive processing properties of the obtainable polymers via the late addition of further diisocyanate with the prepolymer mixture of suitable molecular mass distribution. In addition, the process according to the invention enables good scalability from the laboratory to an industrial scale.

The thermoplastic polyurethane according to the invention is produced in the context of a continuous process. A continuous process has the feature that a continuous supplying of the reactants to the reaction system over time is effected. In addition, the resulting product is continuously removed from the reaction system over time. In particular, the continuous process is a continuous loop process in which at least one component formed during the process is conveyed to another reaction site earlier in the process sequence.

The thermoplastic polyurethane (TPU) according to the invention is a plastic which at room temperature behaves comparably to classical thermoplastics such as polyamides, aromatic polyesters (for example polyethylene terephthalate or polybutylene terephthalate), polystyrene or polycarbonate and under temperature elevation melts to allow forming.

In the context of the present invention, the word “a” in connection with countable parameters is to be understood as meaning the number “one” only when this is stated explicitly (for instance by the expression “precisely one”). Where reference is made hereinbelow to for example “a diol”, the word “a” is to be understood as meaning merely the indefinite article and not the number “one”; an embodiment comprising a mixture of at least two diols is therefore also covered by this.

Continuous process(es) for the purposes of the invention are those in which the reactants are added to the reaction system continuously over time. In addition the resulting product is continuously removed from the reaction system over time. More particularly, the continuous process is a continuous loop process in which at least one component formed during the process is conveyed to another reaction site earlier in the process sequence. The continuous process mode is usually economically advantageous, since reactor shutdown times as a result of charging and discharging processes are avoided.

Those skilled in the art will know that polymers and hence also prepolymers are not present as isolated species in polyurethane chemistry, but rather always as mixtures of molecules having different numbers of repeat units and hence different molecular weights and sometimes different end groups too. Both the number of repeat units per molecule and sometimes the end groups too generally show a statistical distribution.

In the context of the present invention, the term “hydroxy-terminated prepolymer” is understood as meaning a prepolymer mixture in which at least 90% (by number) of molecular ends have a hydroxy group and the remaining 10% (by number) of molecular ends have further hydroxy groups, NCO groups and/or non-reactive groups. A “non-reactive group” in the context of the present invention is understood as meaning a group that, under the reaction conditions of the invention, reacts neither with NCO groups nor with OH groups within a unit of time that corresponds to the reaction time of the invention. A non-reactive group may, for example, be converted from a reactive NCO group or OH group through reaction with suitable co-reactants (chain terminators) to form a non-reactive group. Suitable chain terminators are all monofunctional compounds that under the reaction conditions of the invention react either with an isocyanate group or with a hydroxy group, for example monoalcohols such as methanol, monoamines such as diethylamine, and monoisocyanates such as butyl isocyanate. The hydroxy-terminated prepolymer may, for example, have a hydroxy group at one end of the molecule and, for example, an alkyl group at the other end(s) of the molecule. Where reference is made to a hydroxy-terminated prepolymer in the context of the present invention, this therefore always also encompasses a mixture of the at least one hydroxy-terminated prepolymer and a non-reactively terminated prepolymer. In addition, based on the statistics of the reaction, disregarding side reactions, it may also be a mixture comprising non-hydroxy-terminated up to doubly hydroxy-terminated prepolymers. It is preferably a mixture predominantly of doubly hydroxy-terminated prepolymers. In accordance with the invention, the at least one hydroxy-terminated prepolymer may also be a mixture of at least one hydroxy-terminated prepolymer and at least one non-reactively terminated prepolymer.

In the context of the present invention, a “non-reactively terminated prepolymer” or a “non-reactively terminated polymer” is understood as meaning respectively a prepolymer or polymer in which the reactive groups (NCO groups or OH groups) have been converted by reaction with suitable co-reactants (chain terminators) into chemical groups that do not react either with NCO groups or with OH groups under the reaction conditions mentioned. Examples of suitable chain terminators are monoalcohols such as methanol, monoamines such as diethylamine, and monoisocyanates such as butyl isocyanate. The molar proportion of the chain terminators may be for example from 0.001 mol % to 2 mol % and preferably from 0.002 mol % to 1 mol %, in each case based on the total molar amount of the corresponding monomer component.

Polyisocyanates are in this connection understood as meaning organic compounds having two or more isocyanate groups, irrespective of whether these have been obtained by phosgenation or by phosgene-free methods. Examples of suitable polyisocyanates having three isocyanate groups are triphenylmethane 4,4′,4″-triisocyanate or isocyanatomethyloctane 1,8-diisocyanate (TIN).

In the context of the present invention, the term “polyol” is understood as meaning any organic monomeric or polymeric substance having two or more hydroxy groups capable of reacting with an NCO group.

In accordance with the invention, the terms “comprising” or “containing” preferably mean “consisting essentially of” and more preferably mean “consisting of”.

Process step a) comprises producing a mixture of component (A), component (B) and optionally component (C). In this step, the individual monomer components and optionally component (C) are combined by stirring or through the use of shear forces so as to obtain a dispersion of one of the components in the other component. Depending on the solubility of the components in one another, the mixture may be present as one or more phases; for most systems it is present as two phases. This process step may advantageously be carried out at a temperature at which the two components have not yet reacted with one another to an appreciable extent. The monomers have not yet reacted with one another to an appreciable extent when at least 70 mol %, preferably at least 90 mol %, more preferably at least 98 mol %, of the monomers capable of reacting have not yet reacted with one another. In order to obtain the mixture of monomers on mixing, the temperatures can be held within a temperature range of for example 20° C. to 100° C. The dwell time in this mixing process before the mixture passes into the next process step may preferably be less than one minute, preferably less than 10 seconds. A further essential process feature is that at this juncture only a partial amount of component (A) is mixed with a partial amount or the total amount of component (B). A partial amount of component (A) means that further, significant amounts of component (A) are fed into the process at a later process juncture. A further amount of component (A) is significant when it constitutes more than 2.5 mol %, preferably more than 5 mol % and more preferably more than 10 mol % of the total amount of component (A).

Process step b) comprises mixing the mixture produced in process step a) with a prepolymer output substream obtained from process step e). In this process step, a mixture consisting essentially of monomers of components (A) and (B) is thus mixed with a stream from a later phase in the process which essentially consists not of monomers of components (A) and (B) but of prepolymers of the two monomers. Prepolymers are reaction products from the reaction of monomers of component (A) with monomers of component (B), wherein the average degree of polymerization n of the prepolymers is in a range from 1.5 to 19, preferably in the range from 2 to 9 and more preferably in the range from 3.2 to 6, wherein

n=x/1−x and wherein x is the ratio of the isocyanate groups in component (A) to the hydroxy groups in component (B).

The prepolymers are preferably essentially hydroxy-terminated prepolymers. “Essentially” in this context means that at least 95 mol %, preferably at least 98 mol %, more preferably at least 99 mol % and particularly preferably at least 99.5 mol %, of the prepolymers are hydroxy-terminated prepolymers.

Process step c) comprises reacting the mixture from process step b). The reacting comprises forming larger molecules from the individual monomers of components (A) and (B) by polyaddition. However, the reacting does not necessarily mean that the totality of the monomers present will be incorporated into polymer chains. If an excess of component (B) is present, component (B) in particular will still be present in the resulting reaction mixture. The residual monomer content based on the total molar amount of all monomers used that has not been incorporated into chains is preferably within a range from 0.12 mol % to 16 mol %, preferably within a range from 0.52 mol % to 12 mol % and more preferably within a range from 7.6 mol % to 1.1 mol %. The mixture can in this step advantageously be thermally equilibrated by means of suitable process media.

Process step d) comprises dividing the reaction mixture obtained in step c) into two output substreams. After formation of the prepolymers from the monomers of components (A) and (B) the obtained reaction mixture is upon exiting this reaction stage divided and passed to two different reaction sites via two different conduits. One conduit contains a portion of the output stream and recycles this to an earlier process step while the remaining portion is passed into the subsequent process step. The former is part of process step e) which effects recycling of an output substream from process step d) as an input substream for the mixing in process step b). A portion of the prepolymer from process step d) is thus passed into process step b), i.e. into the as yet unreacted mixture of the monomers of components (A) and (B).

In process step f) the remainder of the output stream from process step d) is mixed with the remainder of component (A) and optionally with the remainder of component (B) and forms further process stream d).

Process step g) comprises reacting to completion the mixture obtained in process step f) to obtain a thermoplastic polyurethane. The reacting to completion may be induced for example through temperatures of the process streams and comprises further reaction of the monomers with prepolymers, preferably hydroxy-terminated prepolymers, to form polymers. The reacting to completion may be effected via the temperature of the mixture, by temperature elevation or else by temperature elevation in conjunction with a mechanical treatment, for example in the form of an extrusion. Higher or lower pressures may also be used in addition to shear stress. It is also possible to perform further measures, for example degassing by application of negative pressure, in the course of this step. This can contribute to uniformization of the properties of the polymer. The material can also be further conditioned via subsequent processing steps. For example by cooling and solidifying, preferably through water cooling, and converting into a bulk solid through an additional pelletization step.

Suitable as component (A) are all aliphatic, cycloaliphatic and/or araliphatic polyisocyanates, especially monomeric diisocyanates, that are known to those skilled in the art. Suitable compounds are preferably those in the molecular weight range from ≥140 g/mol to ≤400 g/mol, irrespective of whether these have been obtained by phosgenation or by phosgene-free methods. The polyisocyanates and/or precursor compounds thereof may have been obtained from fossil or biological sources. Preference is given to preparing 1,6-diisocyanatohexane (HDI) from hexamethylene-1,6-diamine and 1,5-diisocyanatopentane from pentamethylene-1,5-diamine, with hexamethylene-1,6-diamine and pentamethylene-1,5-diamine having been obtained from biological sources, preferably by bacterial fermentation.

Where reference is made to component (A) in the context of the present invention, this may also be a mixture of at least two components (A).

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

Examples of suitable cycloaliphatic diisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

Examples of suitable araliphatic diisocyanates are 1,3- and 1,4-bis(isocyanatomethyl)benzene (xylylene diisocyanate; XDI), 1,3- and 1,4-bis(1-isocyanato-1-methylethyl)benzene (TMXDI).

Further diisocyanates that are likewise suitable can additionally be found, for example, in Houben-Weyl “Methoden der organischen Chemie” [Methods of Organic Chemistry], volume E20 “Makromolekulare Stoffe” [Macromolecular Materials], Georg Thieme Verlag, Stuttgart, N.Y. 1987, pp. 1587-1593 or in Justus Liebigs Annalen der Chemie volume 562 (1949) pp. 75-136.

In a preferred embodiment of the process according to the invention, the component (A) employed is one or more aliphatic and/or cycloaliphatic, monomeric diisocyanates having a molecular weight in the range from ≥140 g/mol to ≤400 g/mol.

In the context of the present invention, the term “monomeric diisocyanate” is understood as meaning a diisocyanate that includes no dimeric, trimeric, etc. structures, is part of dimeric, trimeric, etc. structures, and/or is a product of the reaction of an NCO group with an NCO-reactive group, for example urethane, urea, carbodiimide, acylurea, amide, isocyanurate, allophanate, biuret, oxadiazinetrione, uretdione and/or iminooxadiazinedione structures.

In a further preferred embodiment of the process according to the invention the component (A) employed is one or more monomeric diisocyanates selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI) and/or mixtures of at least 2 of these, preferably selected from the group consisting of 1,4-diisocyanatobutane (BDI), 1,5-diisocyanatopentane (PDI), 1,6-diisocyanatohexane (HDI) and/or mixtures of at least two of these, and more preferably selected from the group consisting of 1,5-diisocyanatopentane (PDI), 1,6-diisocyanatohexane (HDI) and/or mixtures of at least two of these.

The component (B) employed according to the invention is one or more cycloaliphatic, aliphatic and/or araliphatic polyols having a hydroxyl number of 600 mg KOH/g to 1830 mg KOH/g, determined in accordance with DIN EN ISO 4629-2:2016. The polyols and/or precursor compounds thereof may have been obtained from fossil or biological sources. The aliphatic polyols include in particular also heteroaliphatic polyols, i.e. polyols in which CH groups and/or CH₂ groups of the aliphatic chain have been replaced by heteroatoms such as N, S or O. Examples of heteroaliphatic polyols in accordance with the invention are ethylene glycol, butylene glycol, diethylene glycol, HOCH₂CH₂SCH₂CH₂OH, N(CH₂OH)₃ and HOCH₂N(CH₃)CH₂OH. Further examples of suitable polyols are propane-1,2-diol, propane-1,3-diol, butane-1,3-diol, butane-1,4-diol, hexane-1,6-diol and isomers, neopentyl glycol, trimethylolpropane, glycerol, erythritol, pentaerythritol, trimethylolbenzene or trishydroxyethyl isocyanurate.

In a preferred embodiment of the process according to the invention, the component (B) employed is one or more cycloaliphatic, aliphatic and/or araliphatic polyols having a hydroxyl number of 600 mg KOH/g to 1830 mg KOH/g, determined in accordance with DIN EN ISO 4629-2:2016, preferably one or more cycloaliphatic and/or aliphatic diols having a hydroxyl number of 600 mg KOH/g to 1830 mg KOH/g, determined in accordance with DIN EN ISO 4629-2:2016.

In a further preferred embodiment of the process according to the invention, the component (B) employed is one or more diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-diol, -1,3-diol and -1,4-diol, cyclohexane-1,4-dimethanol, diethylene glycol and/or mixtures of at least 2 of these, preferably selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least 2 of these, more preferably selected from the group consisting of ethane-1,2-diol, propane-1,2-diol, propane-1,3-diol, butane-1,2-diol, butane-1,3-diol, butane-1,4-diol and/or mixtures of at least 2 of these.

In a further preferred embodiment of the process according to the invention, the hydroxy-terminated prepolymers are essentially formed by polyaddition of combinations of component (A) and component (B) selected from the group consisting of 1,4-diisocyanatobutane with ethane-1,2-diol, 1,4-diisocyanatobutane with propane-1,2-diol and/or -1,3-diol, 1,4-diisocyanatobutane with butane-1,2-diol, -1,3-diol and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2-diol and/or -1,3-diol, 1,5-diisocyanatopentane with butane-1,2-diol, -1,3-diol and/or -1,4-diol, 1,5-diisocyanatopentane with pentane-1,5-diol, 1,5-diisocyanatopentane with hexane-1,6-diol, 1,6-diisocyanatohexane with ethane-1,2-diol, 1,6-diisocyanatohexane with propane-1,2-diol and/or -1,3-diol, 1,6-diisocyanatohexane with butane-1,2-diol, -1,3-diol and/or -1,4-diol, 1,6-diisocyanatohexane with pentane-1,5-diol and 1,6-diisocyanatohexane with hexane-1,6-diol, preferably selected from the group consisting of 1,4-diisocyanatobutane with ethane-1,2-diol, 1,4-diisocyanatobutane with propane-1,2-diol and/or -1,3-diol, 1,4-diisocyanatobutane with butane-1,2-diol, -1,3-diol and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2-diol and/or -1,3-diol, 1,5-diisocyanatopentane with butane-1,2-diol, -1,3-diol and/or -1,4-diol, 1,5-diisocyanatopentane with pentane-1,5-diol, 1,6-diisocyanatohexane with ethane-1,2-diol, 1,6-diisocyanatohexane with propane-1,2-diol and/or -1,3-diol and 1,6-diisocyanatohexane with butane-1,2-diol, -1,3-diol and/or -1,4-diol, more preferably selected from the group consisting of 1,5-diisocyanatopentane with butane-1,2-diol, butane-1,3-diol, butane-1,4-diol and/or mixtures of at least 2 of these and 1,6-diisocyanatohexane with butane-1,2-diol, butane-1,3-diol, butane-1,4-diol and/or mixtures of at least 2 of these.

In a further preferred embodiment of the process according to the invention, the hydroxy-terminated prepolymers are preferably obtained through reaction of essentially 1,6-diisocyanatohexane with butane-1,4-diol.

In a further preferred embodiment of the process according to the invention, the prepolymers, preferably the hydroxy-terminated prepolymers, have an average OH functionality calculated from the functionalities of the reactants of 1.8 to 2.1, preferably 1.95 to 2.05, more preferably 1.97 to 2.0, most preferably 1.975 to 2.0.

In a further preferred embodiment of the process according to the invention, the thermoplastic polyurethane according to the invention is essentially formed by polyaddition of combinations of component (A) and component (B) selected from the group consisting of 1,4-diisocyanatobutane with ethane-1,2-diol, 1,4-diisocyanatobutane with propane-1,2-diol and/or -1,3-diol, 1,4-diisocyanatobutane with butane-1,2-diol, -1,3-diol and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2-diol and/or -1,3-diol, 1,5-diisocyanatopentane with butane-1,2-diol, -1,3-diol and/or -1,4-diol, 1,5-diisocyanatopentane with pentane-1,5-diol, 1,5-diisocyanatopentane with hexane-1,6-diol, 1,6-diisocyanatohexane with ethane-1,2-diol, 1,6-diisocyanatohexane with propane-1,2-diol and/or -1,3-diol, 1,6-diisocyanatohexane with butane-1,2-diol, -1,3-diol and/or -1,4-diol, 1,6-diisocyanatohexane with pentane-1,5-diol and 1,6-diisocyanatohexane with hexane-1,6-diol, preferably selected from the group consisting of 1,4-diisocyanatobutane with ethane-1,2-diol, 1,4-diisocyanatobutane with propane-1,2-diol and/or -1,3-diol, 1,4-diisocyanatobutane with butane-1,2-diol, -1,3-diol and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2-diol and/or -1,3-diol, 1,5-diisocyanatopentane with butane-1,2-diol, -1,3-diol and/or -1,4-diol, 1,5-diisocyanatopentane with pentane-1,5-diol, 1,6-diisocyanatohexane with ethane-1,2-diol, 1,6-diisocyanatohexane with propane-1,2-diol and/or -1,3-diol and 1,6-diisocyanatohexane with butane-1,2-diol, -1,3-diol and/or -1,4-diol, more preferably selected from the group consisting of 1,5-diisocyanatopentane with butane-1,2-diol, butane-1,3-diol, butane-1,4-diol and/or mixtures of at least 2 of these and 1,6-diisocyanatohexane with butane-1,2-diol, butane-1,3-diol, butane-1,4-diol and/or mixtures of at least 2 of these.

In a further preferred embodiment of the process according to the invention, the thermoplastic polyurethane is preferably obtained through reaction of essentially 1,6-diisocyanatohexane with butane-1,4-diol.

“Essentially” in this context means that at least 95 mol %, preferably at least 98 mol %, more preferably at least 99 mol %, particularly preferably at least 99.5 mol %, very particularly preferably at least 99.8 mol % and most preferably 100 mol % of the hydroxy-terminated prepolymers are formed from the recited monomer components (A) and (B).

In the process according to the invention, components (A) and (B) may optionally be reacted in the presence of one or more catalysts and/or additives, preferably in the presence of one or more heavy metal-free catalysts and/or additives.

To accelerate the reaction it is possible to employ, for example, customary catalysts known from polyurethane chemistry. Examples include tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo[5.4.0]undec-7-ene (DBU), 1,2-dimethylimidazole, 2-methylimidazole, N,N-dimethylimidazole-p-phenylethylamine, 1,4-diazabicyclo[2,2,2]octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine and/or bis(dimethylaminoethyl) ether; metal salts, for example inorganic and/or organic compounds of iron, lead, bismuth, zinc and/or tin in customary oxidation states of the metal, for example iron(II) chloride, iron(III) chloride, bismuth(III) bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutyltin(IV) dichloride or lead octoate; amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, and alkali metal alkoxides, for example sodium methoxide and potassium isopropoxide, and alkali metal salts of long-chain fatty acids having 10 to 20 carbon atoms and optionally pendant OH groups.

Preferred catalysts are tertiary amines that are known and customary in the prior art, for example triethylamine, dimethylcyclohexylamine, N-methylmorpholine, N,N′-dimethylpiperazine, 2-(dimethylaminoethoxy)ethanol, diazabicyclo[2,2,2]octane and similar heavy metal-free catalysts.

The catalyst is generally used in amounts of 0.001% to 2.0% by weight, preferably of 0.005% to 1.0% by weight, more preferably of 0.01% to 0.1% by weight, based on component (A). The catalyst can be used in neat form or dissolved in component (B). One advantage of this is that the thermoplastic polyurethane then obtained does not contain any impurities as a result of any catalyst solvents additionally used. The catalyst can be added in one or more portions or else continuously, for example with the aid of a suitable metering pump, over the entire duration of the reaction.

However, it is alternatively possible also to use mixtures of the catalyst(s) with a catalyst solvent, preferably with an organic catalyst solvent. The degree of dilution of the catalyst solutions is freely choosable within a very wide range. Catalytically active solutions are those of a concentration over and above 0.001% by weight.

Suitable catalyst solvents are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl ether acetate or ethylene glycol monoethyl ether acetate, diethylene glycol ethyl and butyl ether acetate, propylene glycol monomethyl ether acetate, 1-methoxy-2-propyl acetate, 3-methoxy-n-butyl acetate, propylene glycol diacetate, acetone, methyl ethyl ketone, methyl isobutyl ketone, cyclohexanone, lactones, such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

Alternatively, in the process according to the invention it is possible to use catalyst solvents that bear groups that are reactive toward isocyanates and can be incorporated into the prepolymer. Examples of such solvents are mono- and polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

In a preferred embodiment, components (A) and (B) are reacted with one another without a catalyst in the process according to the invention. It has been found that the thermoplastic polyurethane according to the invention may be obtained without the use of polymerization catalysts. This is surprising, since obtaining a homogeneous thermoplastic polyurethane typically involves the use of catalysts.

In addition to components (A) and (B) and the catalysts, additives may also be used. These may for example be standard additives in the field of polyurethane technology, such as dyes, fillers, processing auxiliaries, plasticizers, nucleating agents, stabilizers, flame retardants, demolding agents or reinforcing additives. Further information about the auxiliaries and additives mentioned may be found in the specialist literature, for example in the monograph by J. H. Saunders and K. C. Frisch “High Polymers”, Volume XVI, Polyurethane, Part 1 and 2, Interscience Publishers 1962/1964, in “Taschenbuch für Kunststoff-Additive” [“Handbook of Plastics Additives”] by R. Gächter and H. Müller (Hanser Verlag Munich 1990) or in DE-A 29 01 774. It will be self-evident that it can likewise be advantageous to use a plurality of additives of a plurality of types.

In a preferred embodiment, it is also possible to use small amounts of aromatic diisocyanates as additives in proportions of up to 2% by weight based on the molar amount of component (A). Examples of suitable aromatic diisocyanates are 2,4- and 2,6-diisocyanatotoluene (TDI), 2,4′- and 4,4′-diisocyanatodiphenylmethane (MDI) and 1,5-diisocyanatonaphthalene.

In a preferred embodiment, no aromatic diisocyanates and no polyisocyanates (according to the above definition) are used in the process according to the invention.

In another preferred embodiment, additives used in small amounts may also be customary isocyanate-reactive mono-, di-, tri- or polyfunctional compounds in proportions of up to 2% by weight, based on the total weight of the prepolymer(s), for example as chain terminators, auxiliaries or demolding aids. Examples include alcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol and stearyl alcohol. Examples of suitable triols are trimethylolethane, trimethylolpropane or glycerol. Suitable higher-functionality alcohols are ditrimethylolpropane, pentaerythritol, dipentaerythritol or sorbitol. Amines such as butylamine and stearylamine or thiols. These additives may be added up to an amount at which the limits for OH functionality according to the invention are not exceeded.

In a preferred embodiment of the process according to the invention, the reaction of components (A), (B) and (C) (if used) is carried out solvent-free.

A “solvent-free process” in the context of the present invention is understood as meaning the reaction of components (A) and (B) without additional diluents, such as organic solvents or water, i.e. components (A) and (B) are preferably reacted with one another in undiluted form. Component (C) may optionally be present in suitable diluents and be added in the form of a solution or dispersion to components (A) and/or (B). For the purposes of the present invention, the process is still considered to be solvent-free when the solvent content is not more than 1% by weight, preferably not more than 0.1% by weight, more preferably not more than 0.01% by weight, based on the total weight of the reaction mixture. A solvent is understood here as meaning a substance in which at least one of components (A) and (B) or (C) (if used) can be dissolved, dispersed, suspended or emulsified, but which does not react with either of components (A) and (B) or with (C) (if used) or with the hydroxy-terminated prepolymer(s). In the context of the present invention, a non-reactively terminated prepolymer and/or non-reactively terminated polymer that does not react with either of components (A) and (B) or with (C) (if used) or with the hydroxy-terminated prepolymer(s) of the reaction mixture is not regarded as a “solvent”.

In a further preferred embodiment of the process according to the invention, process step a) employs the total amount of component (B).

In a further preferred embodiment of the process according to the invention, components (A) and (B) are altogether employed in a molar ratio in the range from 0.9:1.0 to 1.2:1.0 over all process steps.

In a further preferred embodiment of the process according to the invention, the temperature in process step a) is not less than 25° C. and not more than 60° C. This temperature range has been found to be particularly suitable for obtaining a mixture of monomers of components (A) and (B) that is as uniform as possible and has a low content of already partially reacted monomers. Lower temperatures can be unfavorable, because the viscosity of the constituents is then too high and only an inadequate premix is obtainable. Furthermore, short-chain diols can freeze out, especially if 1,4-butanediol is concerned. Higher temperatures can be disadvantageous, because the content of already partially reacted monomers then becomes too high. Preferred temperature ranges during this step may preferably be between greater than or equal to 35° C. and less than or equal to 55° C., more preferably between greater than or equal to 40° C. and less than or equal to 50° C.

In a further preferred embodiment of the process according to the invention, the temperature in process step c) is greater than or equal to 170° C. and less than or equal to 190° C. This temperature range has been found to be particularly suitable for forming an adequate and suitable prepolymer concentration and composition. Without being bound by a particular theory, it appears that, within appropriate dwell times, the reacted prepolymers show a narrow molecular mass distribution. It is preferably possible to obtain these prepolymers with a dwell time within the temperature range cited above of 5 minutes to 35 minutes.

In a further preferred embodiment of the process according to the invention, at least process step g) is performed in an extruder. It is preferable when process steps f) and g) are performed in an extruder. The thermoplastic polymer that has reacted to completion is extruded from process step g). To obtain a homogeneous polymer, it has proven suitable when the reacting to completion of the remaining partial amount of component (A) with the already formed prepolymers to afford the polymers is effected not only on the basis of temperature elevation, but also with simultaneous application of shear forces. In addition to simultaneously promoting homogeneous mixing of the melt, the shear forces may also contribute to obtaining a particular orientation of the polymer chains formed.

Suitable extruders are, for example, co-rotating multi-screw extruders such as two-screw or four-screw extruders or ring extruders, counter-rotating multi-screw extruders, co-kneaders or planetary roll extruders and rotor-stator systems.

In a further preferred embodiment of the process according to the invention, the temperatures in process step g) are not less than 180° C. and not more than 260° C. It is preferable when the temperatures in the barrel of the extruder in direct contact with the polymer melt in process step g) are not less than 180° C. and not more than 260° C. In this temperature range reproducibility is particularly high and thermal stress is particularly low, which also has the result that few side reactions occur.

After this temperature step the concentration of free monomers is extremely low and there is no risk of undesired temperature-induced chain degradation. The result is a reproducible molecular weight distribution which contributes to the suitable polymer properties. Higher temperatures may be disadvantageous since the risk of undesired polymer degradation then increases. Lower temperatures may be undesirable since the residence time to obtain a polymer that has largely reacted to completion then becomes excessively long.

In a further preferred embodiment of the process, the molar ratio of the partial amounts of component (A) employed in process step a) and in process step f), calculated as moles of component (A) in a)/[moles of component (A) in f) plus moles of component (A) in a)], is not less than 0.9 and not more than 0.65. This ratio can contribute to obtaining a particularly homogeneous mixture in the extrusion step.

In a further preferred embodiment of the process according to the invention, the weight ratio of the prepolymers fed back in process step b) based on the amount of employed mixture of component (A) and component (B) is greater than or equal to 10 and less than or equal to 30. Without being bound by a particular theory, this ratio of feedback to monomer addition can have a particularly strong influence on temperature control. Specifically, it is additionally very advantageous when the temperature in this process step is kept within narrow limits. The lowest temperature in this process step is typically after mixing the monomers with the prepolymer and the highest temperature is in the output from the process step. Cooling may, for example, be provided at this point. The temperature difference between these points may preferably be not more than 20 K, more preferably less than 10 K.

In a further preferred embodiment of the process according to the invention, the partial amount of component (A) and optionally partial amount of component (B) and/or partial amount of component (C) added in process step f) has a temperature of not less than 10° C. and not more than 150° C. This temperature is particularly useful for the incorporation in the extrusion step since the added partial amount of component (A) and optionally partial amount of component (B) cools the prepolymer stream and thus limits the maximum temperature occurring in the process. In addition, the temperature may preferably be between not less than 20° C. and not more than 60° C.

In a further preferred embodiment of the process according to the invention, the prepolymers of the output stream from step e) essentially consist of hydroxy-terminated prepolymers “Essentially” in this context means that at least 95 mol %, preferably at least 98 mol %, particularly preferably at least 99 mol % and more preferably at least 99.5 mol %, yet more preferably at least 99.8 mol % and most preferably 100 mol % of the prepolymers of the output stream from step e) are hydroxy-terminated prepolymers. In a preferred embodiment, the hydroxy-terminated prepolymers have an average OH functionality, calculated from the functionalities of the reactants, of 1.8 to 2.1, preferably 1.95 to 2.05, particularly preferably 1.97 to 2.0, very particularly preferably 1.975 to 2.0.

In a further preferred embodiment of the process according to the invention, at least process steps b), c), d) and e) are performed in a loop reactor.

In a further preferred embodiment of the process according to the invention, the loop reactor has a pressure control means, wherein the pressure is set in the range from 2 bar absolute to 11 bar absolute. “Bar absolute” for the purposes of the invention means the pressure relative to zero pressure in the empty space (vacuum). The positive pressure has the advantage that gaseous secondary components such as residual air, nitrogen, or carbon dioxide that are carried into the reactor with components (A), (B) and (C) (if used) and components of low volatility that may be formed during the reaction, such as tetrahydrofuran through cyclization of butanediol, are kept in the liquid phase, with the result that the volume of the mass present in the loop reactor does not fluctuate due to expansion or contraction of gas bubbles in the reactor with a consequently uneven mass output.

The viscosity is preferably determined or calculated within the process, for example through the measurement of pressure drops in sections of pipe conduit or in static mixers. For laminar flow in circular sections of pipe conduit, the Hagen-Poiseuille equation for calculation of pressure drops (Δp in Pascal) in the form of

$$Δ p = \frac{128}{π} \frac{\dot{V}}{{D}^{3}} η \frac{L}{D}$$

(\dot{V}=volume flow rate in cubic meters per second, D=internal diameter of the pipe through which the flow passes in meters, π≈3,14159 . . . (pi), L=length of the pipe in meters, η=viscosity in pascal seconds) can be rearranged to the equation determining viscosity

$$η = \frac{π}{128} \frac{{D}^{4}}{\dot{V} L} Δ p$$

In a further preferred embodiment of the process according to the invention, the viscosity of the material stream in the loop reactor is below 10 Pa·s, preferably below 3 Pa·s, particularly preferably below 1 Pa·s, at a measurement temperature of 190° C. and a frequency of 10 Hz, determined in accordance with ISO 6721-10:2015.

In a further preferred embodiment of the process according to the invention, the loop reactor has at least one heat exchanger having a heat-transfer capacity, based on the total volume of the loop reactor, of more than 10 kW/(m³·K), preferably of more than 15 kW/(m³·K) and very particularly preferably of more than 20 kW/(m³·K).

In a further preferred embodiment of the process according to the invention, the loop reactor has at least one heat exchanger and the ratio of heat-transfer surface area to loop reactor surface area is >0.3, preferably >0.5 and more preferably >0.65.

In a further preferred embodiment of the process according to the invention, the heat-transfer surface area in the reactor has an average k value of >50 W/(m²·K), preferably >100 W/(m²·K) and more preferably >250 W/(m²·K).

The invention further relates to thermoplastic polyurethane obtainable or obtained by the process according to the invention. In a preferred embodiment, thermoplastic polyurethanes according to the invention are obtained by reaction of essentially 1,6-diisocyanatohexane with butane-1,4-diol. “Essentially” in this context means that at least 95 mol %, preferably at least 98 mol %, particularly preferably at least 99 mol % and more preferably at least 99.5 mol %, yet more preferably at least 99.8 mol % and most preferably 100 mol % of the thermoplastic polyurethane according to the invention is formed from the monomers 1,6-diisocyanatohexane and butane-1,4-diol.

In a further embodiment of the invention, the thermoplastic polyurethane according to the invention is catalyst-free. This is surprising, since obtaining a homogeneous polyurethane polymer typically involves the use of catalysts. The thermoplastic polyurethane according to the invention is catalyst-free when the amount of catalyst is less than 1.0% by weight, preferably less than 0.5% by weight, more preferably less than 0.1% by weight.

The invention further relates to a composition containing at least the thermoplastic polyurethane according to the invention and at least one additive.

The additive may for example be standard additives in the field of thermoplastics technology, such as dyes, fillers, processing auxiliaries, plasticizers, nucleating agents, stabilizers, flame retardants, demolding agents or reinforcing additives. Further details regarding the additives mentioned may be found in the specialist literature, for example the monograph by J. H. Saunders and K. C. Frisch “High Polymers”, Volume XVI, Polyurethane, Part 1 and 2, Interscience Publishers 1962/1964, in “Taschenbuch für Kunststoff-Additive” [“Handbook for Plastics Additives”] by R. Gächter and H. Müller (Hanser Verlag Munich 1990) or in DE-A 29 01 774. Of course, it may likewise be advantageous to use two or more additives of two or more types.

Further advantages and advantageous configurations of the objects according to the invention are illustrated by the drawings and elucidated in the description that follows. It should be noted that the drawings are merely of a descriptive nature and are not intended to limit the invention. In the figures:

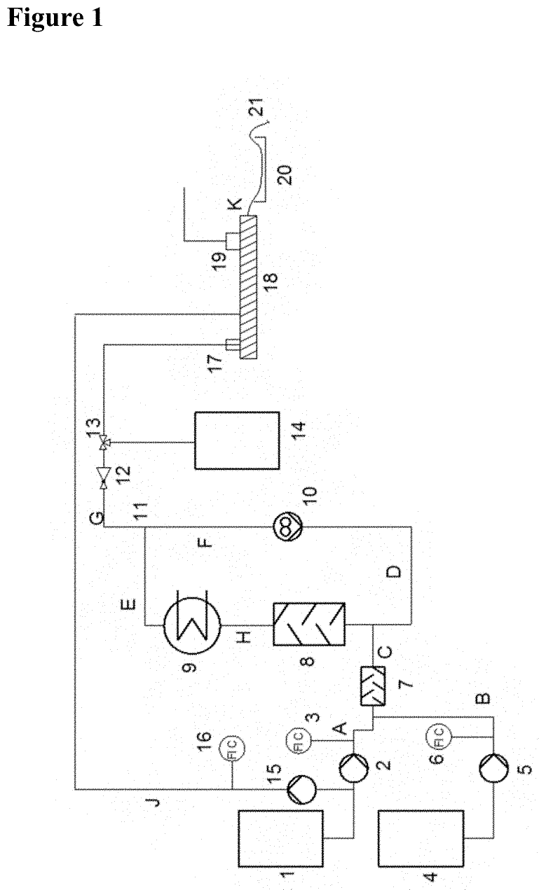

FIG. 1 shows a possible setup for continuous production of the polyurethanes according to the invention; and

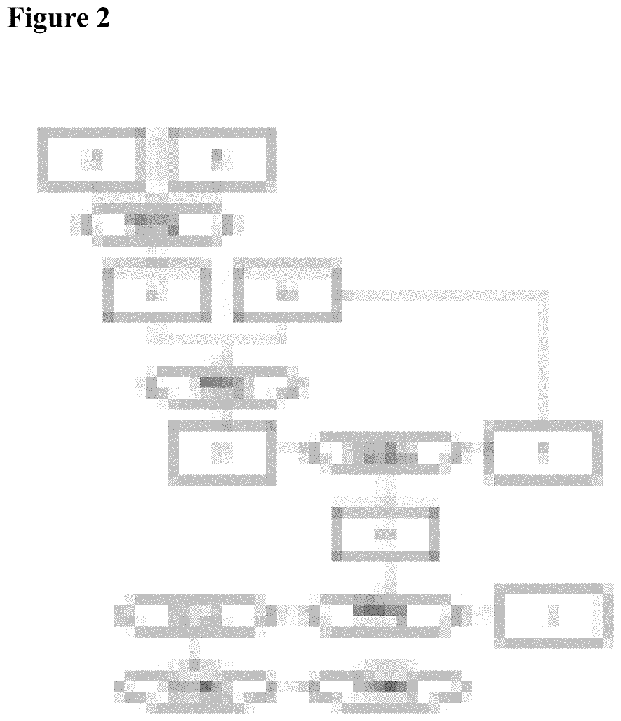

FIG. 2 shows a diagram for definition of the process and the process steps and the material streams of the process according to the invention.

FIG. 1 shows a possible setup for continuous production of hydroxy-terminated prepolymers. The HDI stream (stream A) is withdrawn from the HDI tank 1 by means of a pump 2. The amount withdrawn may be measured via a mass flow meter 3 and optionally controlled by feedback to the pump 2. A similar setup arises for the BDO tank 4 with BDO pump 5 and flow meter 6 (stream B). The two streams A and B are conveyed into the static mixer 7 and mixed with one another to form stream C. Stream C is mixed with a recirculating oligomer stream D in the temperature-controllable mixers 8, 9 to form stream E, with stream E undergoing reaction in the mixers 8, 9 and in the pipe conduits. Stream E is split at the branching point 11 into two substreams (streams F and G). Downstream of the pressure-retaining valve 12, stream G is run past a three-way valve 13. It may be advantageous to run material generated during startup and shutdown of the plant or during malfunctions to a waste container 14. In regular operation, stream G is passed to an extruder 18. An HDI stream J is withdrawn from the container 1 and via a pump 15 and a mass flow meter 16, with which the HDI stream J is measured and optionally controlled, supplied to the extruder 18 in which it is mixed with stream G and the mixture is reacted. The extruder 18 may have apparatuses, 17, 19 for degassing the molten polymer at the inlet and outlet. The extruded polymer stream K may be expressed through nozzles, cooled in a water bath 20 filled with DM water and chopped into pellets by means of a pelletizer 21.

FIG. 2 shows a schematic representation of the sequence of events and the material streams of the process according to the invention. Stream A and B are the reactant streams of components (A) and (B), a portion of the altogether employed amount of component (A) being added via stream A. Component (B) is supplied to the process only via stream B. Streams A and B are mixed (1) (stream C), stream C is then mixed with stream D, stream D being formed by recycling of stream F. The mixture of streams C and D is stream E. Said stream is divided, one of the substreams (stream F) being recycled, i.e. recirculated. The other substream (stream G) is mixed with the other substream of component (A) (stream J) and the mixture is reacted, extruded, cooled and chopped.

### EXAMPLES

All percentages are based on weight unless otherwise stated.

The ambient temperature of 25° C. at the time of performing the experiment is referred to as RT (room temperature).

### I. Raw Materials Used

Hexamethylene 1,6-diisocyanate (HDI, purity ≥99% by weight) was obtained from Covestro Deutschland AG.

Butane-1,4-diol (BDO, purity ≥99% by weight) was obtained from Ashland Industries Deutschland GmbH.

### Example 1

An annular gear pump 2 (HNP, MZR 7255) was used to convey an HDI stream A from a 250 liter tank for HDI 1 to a static mixer 7. The throughput of the HDI stream A was measured using a mass flow meter 3 (Bronkhorst, Mini Cori-Flow M1X, max. flow rate 12 kg/h) and adjusted to a value of 2.911 kg/h. An annular gear pump 5 (HNP, MZR 7205) was used to convey a BDO stream B from a 250 liter tank for BDO 4 to the static mixer 7. The throughput of the BDO stream was measured using a mass flow meter 6 (Bronkhorst, Mini Cori-Flow M1X, max. flow rate 8 kg/h) and adjusted to a value of 2.000 kg/h. The temperature of the HDI was ambient temperature, about 25° C. The temperature of the BDO was 40° C. In the static mixer 7 (Sulzer SMX, diameter 6 mm, length-to-diameter ratio L/D=10) the HDI stream A and the BDO stream B were mixed with one another. This is stream C.

The mixed and dispersed stream C is in a circuit mixed with a circulating polymer stream D in an externally temperature-controlled static mixer 8 (static mixer equivalent to Sulzer SMX, internal diameter 34 mm, L/D=20) to afford a stream H. Heat was also already transferred into this static mixer and the heat transfer surface area was 0.05 square meters. The temperature of stream D was 182° C.

The mixed and already partly reacted stream H was passed into a temperature-controllable static mixer 9. The reaction was largely completed therein and the resulting heat of reaction is removed. The temperature-controllable static mixer 9 was of similar construction to a Sulzer SMR reactor with internal crossed tubes. It had an internal volume of 2.2 liters and a heat exchange surface area of 0.31 square meters. Under the operating conditions, its heat-exchange capacity based on the product side was 78 watts per kelvin. Based on the total volume of the loop reactor of 4 liters, the heat-transfer coefficient was 19 kilowatts per cubic meter per kelvin. It was heated/cooled with heat-transfer oil. The heating medium temperature at the inlet was 180° C.

The ratio of the heat transfer surface area to the total surface area was thus (0.31+0.05)/(0.31+0.05+0.18)=0.655.

The heat-transfer coefficient in the temperature-controllable static mixer was 270 watts per square meter per kelvin.

The product stream exited the temperature-controllable static mixer 9 as a largely fully-reacted stream E at a temperature of 183° C. At a branching 11, stream E was divided into two substreams F and G. The pressure of substream F was increased in a gear pump 10. Substream F became the abovementioned substream D downstream of the pump.

The gear pump 10 (Witte Chem 25,6-3) had a volume per revolution of 25.6 cubic centimeters and a speed of 50 revolutions per minute. The pumped stream G thus amounted to 75 kg/h.

The whole circuit was full and the polymer was largely incompressible. The mass flow rate of stream G was therefore identical to that of stream C. Stream G consisted of oligomer.

The whole circuit consisted of double-walled pipe conduits and apparatuses heated with thermal oil. The heating medium temperature was 182° C.

The mass flow G was then passed through a pressure control valve 12. The pressure in the pressure control valve 12 was over the course of the test controlled in such a way that a pressure in the circuit was between 4 and 7 bar abs. This resulted in a single-phase flow in the entire circuit without exceeding the pressure resistance of all apparatuses.

Downstream of the pressure control valve 12, stream G was run past a three-way valve 13. On startup and shutdown or in the event of faults, it was possible to run said stream G to a waste vessel 14, an open 60 liter metal vat with extraction. In regular operation, stream G was passed to an extruder 18. The stream at the waste container 14 was sampled under steady-state conditions and the viscosity was 0.81 Pa·s at 190° C. and a frequency of 10 Hz.

A micro annular gear pump 15 (MZR 6355 from HNP) was used to withdraw an HDI stream J from the HDI tank 1. The throughput of the HDI stream J was measured using a mass flow meter 16 (Bronkhorst, Mini Cori-Flow M1X, max. flow rate 2 kg/h) and adjusted to 0.784 kilograms per hour. The temperature of the HDI stream J was also room temperature, about 25° C. This stream was also passed to the extruder 18. The extruder 18 was a ZSK 26 MC from Coperion which was operated at a speed of 66 revolutions per minute. In this extruder, stream G was freed of any inert gases entrained with material streams A and B and of possible volatile reaction products by means of a venting system 17 operated at a negative pressure of about 1 mbar relative to ambient pressure. Downstream of the addition of the oligomer stream G, the HDI stream J was added and the reaction to afford the polymer was performed. The resulting polymer stream was also freed of volatile constituents via a degassing 19 before the end of the extruder. The pressure in this degassing was 200 mbar below ambient pressure. The barrel temperatures of the extruder were set to between 190° C. and 210° C. The polymer stream K was expressed through two nozzles, cooled in a water bath filled with demineralized water, and chopped into pellets by means of a pelletizer 21. When the temperature of polymer stream K was measured, a temperature of 208° C. was determined.

### Example 2

An annular gear pump 2 (HNP, MZR 7255) was used to convey an HDI stream A from a 250 liter tank for HDI 1 to a static mixer 7. The throughput of the HDI stream A was measured using a mass flow meter 3 (Bronkhorst, Mini Cori-Flow M1X, max. flow rate 12 kg/h) and adjusted to a value of 4.760 kg/h. An annular gear pump 5 (HNP, MZR 7205) was used to convey a BDO stream B from a 250 liter tank for BDO 4 to the static mixer 7. The throughput of the BDO stream was measured using a mass flow meter 6 (Bronkhorst, Mini Cori-Flow M1X, max. flow rate 8 kg/h) and adjusted to a value of 3.000 kg/h. The temperature of the HDI was ambient temperature, about 25° C. The temperature of the BDO was 40° C. In the static mixer 7 (Sulzer SMX, diameter 6 mm, length-to-diameter ratio L/D=10) the HDI stream A and the BDO stream B were mixed with one another. This is stream C.

The mixed and dispersed stream C is in a circuit mixed with a circulating polymer stream D in an externally temperature-controlled static mixer 8 (static mixer equivalent to Sulzer SMX, internal diameter 34 mm, L/D=20) to afford a stream H. Heat was also already transferred into this static mixer and the heat transfer surface area was 0.05 square meters. The temperature of stream D was 185° C.

The mixed and already partly reacted stream H was passed into a temperature-controllable static mixer 9. The reaction was largely completed therein and the resulting heat of reaction is removed. The temperature-controllable static mixer 9 was of similar construction to a Sulzer SMR reactor with internal crossed tubes. It had an internal volume of 2.2 liters and a heat exchange surface area of 0.31 square meters. Under the operating conditions, its heat-exchange capacity based on the product side was 87 watts per kelvin. Based on the total volume of the loop reactor of 4 liters, the heat-transfer coefficient was 22 kilowatts per cubic meter per kelvin. It was heated/cooled with heat-transfer oil. The heating medium temperature at the inlet was 185° C. The total area of the pipe conduits was 0.18 square meters.

The ratio of the heat transfer surface area to the total surface area was thus (0.31+0.05)/(0.31+0.05+0.18)=0.655.

The heat-transfer coefficient in the temperature-controllable static mixer was 270 watts per square meter per kelvin.

The product stream exited the temperature-controllable static mixer 9 as a largely fully-reacted stream E at a temperature of 185° C. At a branching 11, stream E was divided into two substreams F and G. The pressure of substream F was increased in a gear pump 10. Substream F became the abovementioned substream D downstream of the pump.

The gear pump 10 (Witte Chem 25,6-3) had a volume per revolution of 25.6 cubic centimeters and a speed of 75 revolutions per minute. The pumped stream G thus amounted to 112.5 kg/h.

The whole circuit was full and the polymer was largely incompressible. The mass flow rate of stream G was therefore identical to that of stream C. Stream G consisted of oligomer.

The whole circuit consisted of double-walled pipe conduits and apparatuses heated with thermal oil. The heating medium temperature was 185° C.

The mass flow G was then passed through a pressure control valve 12. The pressure in the pressure control valve 12 was over the course of the test controlled in such a way that a pressure in the circuit was between 4 and 7 bar abs. This resulted in a single-phase flow in the entire circuit without exceeding the pressure resistance of all apparatuses.

Downstream of the pressure control valve 12, stream G was run past a three-way valve 13. On startup and shutdown or in the event of faults, it was possible to run said stream G to a waste vessel 14, an open 60 liter metal vat with extraction. In regular operation, stream G was passed to an extruder 18. The stream at the waste container 14 was sampled under steady-state conditions and the viscosity was 7 Pa·s at 190° C. and a frequency of 10 Hz.

A micro annular gear pump 15 (MZR 6355 from HNP) was used to withdraw an HDI stream J from the HDI tank 1. The throughput of the HDI stream J was measured using a mass flow meter 16 (Bronkhorst, Mini Cori-Flow M1X, max. flow rate 2 kg/h) and adjusted to 0.784 kilograms per hour. The temperature of the HDI stream J was also room temperature, about 25° C. This stream was also passed to the extruder 18.

The extruder 18 was a ZSK 26 MC from Coperion, which was operated at a speed of 180 revolutions per minute. In this extruder, stream G was freed of any inert gases entrained with material streams A and B and of possible volatile reaction products by means of a venting system 17 operated at a negative pressure of about 1 mbar relative to ambient pressure. Downstream of the addition of the oligomer stream G, the HDI stream J was added and the reaction to afford the polymer was performed. The resulting polymer stream was also freed of volatile constituents via a degassing 19 before the end of the extruder. The pressure in this degassing was 600 mbar below ambient pressure. The barrel temperatures of the extruder were set to between 190° C. and 210° C. The polymer stream K was expressed through two nozzles, cooled in a water bath filled with demineralized water, and chopped into pellets by means of a pelletizer 21. When the temperature of polymer stream K was measured, a temperature of 208° C. was determined.

### Example 3

An annular gear pump 2 (HNP, MZR 7255) was used to convey an HDI stream A from a 250 liter tank for HDI 1 to a static mixer 7. The throughput of the HDI stream A was measured using a mass flow meter 3 (Bronkhorst, Mini Cori-Flow M1X, max. flow rate 12 kg/h) and adjusted to a value of 4.591 kg/h. An annular gear pump 5 (HNP, MZR 7205) was used to convey a BDO stream B from a 250 liter tank for BDO 4 to the static mixer 7. The throughput of the BDO stream was measured using a mass flow meter 6 (Bronkhorst, Mini Cori-Flow M1X, max. flow rate 8 kg/h) and adjusted to a value of 3.000 kg/h. The temperature of the HDI was ambient temperature, about 25° C. The temperature of the BDO was 40° C. In the static mixer 7 (Sulzer SMX, diameter 6 mm, length-to-diameter ratio L/D=10) the HDI stream A and the BDO stream B were mixed with one another. This is stream C.

The mixed and dispersed stream C is in a circuit mixed with a circulating polymer stream D in an externally temperature-controlled static mixer 8 (static mixer equivalent to Sulzer SMX, internal diameter 34 mm, L/D=20) to afford a stream H. Heat was also already transferred into this static mixer and the heat transfer surface area was 0.05 square meters. The temperature of stream D was 182° C.

The mixed and already partly reacted stream H was passed into a temperature-controllable static mixer 9. The reaction was largely completed therein and the resulting heat of reaction is removed. The temperature-controllable static mixer 9 was of similar construction to a Sulzer SMR reactor with internal crossed tubes. It had an internal volume of 2.2 liters and a heat exchange surface area of 0.31 square meters. Under the operating conditions, its heat-exchange capacity based on the product side was 87 watts per kelvin. Based on the total volume of the loop reactor of 4 liters, the heat-transfer coefficient was 22 kilowatts per cubic meter per kelvin. It was heated/cooled with heat-transfer oil. The heating medium temperature at the inlet was 180° C.

The ratio of the heat transfer surface area to the total surface area was thus (0.31+0.05)/(0.31+0.05+0.18)=0.655.

The heat-transfer coefficient in the temperature-controllable static mixer was 270 watts per square meter per kelvin.

The product stream exited the temperature-controllable static mixer 9 as a largely fully-reacted stream E at a temperature of 183° C. At a branching 11, stream E was divided into two substreams F and G. The pressure of substream F was increased in a gear pump 10. Substream F became the abovementioned substream D downstream of the pump.

The gear pump 10 (Witte Chem 25,6-3) had a volume per revolution of 25.6 cubic centimeters and a speed of 50 revolutions per minute. The pumped stream G thus amounted to 75 kg/h.

The whole circuit was full and the polymer was largely incompressible. The mass flow rate of stream G was therefore identical to that of stream C. Stream G consisted of oligomer.

The whole circuit consisted of double-walled pipe conduits and apparatuses heated with thermal oil. The heating medium temperature was 182° C.

The mass flow G was then passed through a pressure control valve 12. The pressure in the pressure control valve 12 was over the course of the test controlled in such a way that a pressure in the circuit was between 4 and 9 bar abs. This resulted in a single-phase flow in the entire circuit without exceeding the pressure resistance of all apparatuses.

Downstream of the pressure control valve 12, stream G was run past a three-way valve 13. On startup and shutdown or in the event of faults, it was possible to run said stream G to a waste vessel 14, an open 60 liter metal vat with extraction. In regular operation, stream G was passed to an extruder 18. The stream at the waste container 14 was sampled under steady-state conditions and the viscosity was 2.3 Pa·s at 190° C. and a frequency of 10 Hz.

A micro annular gear pump 15 (MZR 6355 from HNP) was used to withdraw an HDI stream J from the HDI tank 1. The throughput of the HDI stream J was measured using a mass flow meter 16 (Bronkhorst, Mini Cori-Flow M1X, max. flow rate 2 kg/h) and adjusted to 0.952 kilograms per hour. The temperature of the HDI stream J was also room temperature, about 25° C. This stream was also passed to the extruder 18.

The extruder 18 was a ZSK 26 MC from Coperion, which was operated at a speed of 66 revolutions per minute. In this extruder, stream G was freed of any inert gases entrained with material streams A and B and of possible volatile reaction products by means of a venting system 17 operated at a negative pressure of about 1 mbar relative to ambient pressure. Downstream of the addition of the oligomer stream G, the HDI stream J was added and the reaction to afford the polymer was performed. The resulting polymer stream was also freed of volatile constituents via a degassing 19 before the end of the extruder. The pressure in this degassing was 200 mbar below ambient pressure. The barrel temperatures of the extruder were set to between 190° C. and 260° C. The polymer stream K was expressed through two nozzles, cooled in a water bath filled with demineralized water, and chopped into pellets by means of a pelletizer 21. When the temperature of polymer stream K was measured, a temperature of 248° C. was determined.

1. A process for continuous production of thermoplastic polyurethane by reaction of components
(A) one or more cycloaliphatic, aliphatic and/or araliphatic polyisocyanates,
(B) one or more cycloaliphatic, aliphatic and/or araliphatic polyols, wherein the total amount of component (B) has a hydroxyl number of 600 mg KOH/g to 1830 mg KOH/g, determined in accordance with DIN EN ISO 4629-2:2016,
(C) optionally in the presence of one or more catalysts and/or one or more additives,
wherein the process comprises the steps of:
a) producing a mixture of a partial amount of component (A), a partial amount or the total amount of component (B) and optionally a partial amount or the total amount of component (C), wherein a molar ratio of component (A) to component (B) in process step a) is in the range from 0.6:1.0 to 0.95:1.0;
b) mixing the mixture produced in process step a) with a prepolymer output substream obtained from process step e);
c) reacting the mixture from process step b);
d) dividing the reaction mixture obtained in step c) into two output substreams;
e) recycling an output substream from process step d) as an input substream for the mixture in process step b);
f) mixing the remainder of component (A) and optionally the remainder of components (B) and (C) with the remaining output substream of process step d);
g) reacting to completion the mixture obtained in process step f) to obtain a thermoplastic polyurethane.

2. The process as claimed in claim 1, wherein the component (A) employed is one or more aliphatic and/or cycloaliphatic, monomeric diisocyanates having a molecular weight in the range from ≥140 g/mol to ≤400 g/mol.

3. The process as claimed in claim 1, wherein the component (A) employed is one or more monomeric diisocyanates selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI) and/or mixtures of at least 2 of these.

4. The process as claimed in claim 1, wherein the component (B) employed is one or more cycloaliphatic, aliphatic and/or araliphatic polyols having a hydroxyl number of 600 mg KOH/g to 1830 mg KOH/g, determined in accordance with DIN EN ISO 4629-2:2016.

5. The process as claimed in claim 1, wherein the component (B) employed is one or more diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-diol, -1,3-diol and -1,4-diol, cyclohexane-1,4-dimethanol, diethylene glycol and/or mixtures of at least 2 of these.

6. The process as claimed claim 1, wherein process step a) employs the total amount of component (B).

7. The process as claimed in claim 1, wherein the components (A) and (B) are altogether employed in a molar ratio in the range from 0.9:1.0 to 1.2:1.0 over all process steps.

8. The process as claimed in claim 1, wherein the temperature in process step a) is not less than 25° C. and not more than 60° C.

9. The process as claimed in claim 1, wherein the temperature in process step c) is not less than 170° C. and not more than 190° C.

10. The process as claimed in claim 1, wherein at least process step g) is performed in an extruder and optionally wherein the temperatures in process step g) are not less than 180° C. and not more than 260° C.

11. (canceled)

12. The process as claimed in claim 1, wherein the molar ratio of the partial amounts of component (A) employed in process step a) and in process step f), calculated as moles of component (A) in a)/[moles of component (A) in f) plus moles of component (A) in a)], is not less than 0.9 and not more than 0.65.

13. The process as claimed in claim 1, wherein the weight ratio of the prepolymer recycled in process step b) based on the amount of mixture of component (A) and component (B) employed is not less than 10 and not more than 30.

14. The process as claimed in claim 1, wherein the partial amount of component (A) and optionally partial amount of component (B) and/or partial amount of component (C) added in process step f) has a temperature of not less than 10° C. and not more than 150° C.

15. The process as claimed in claim 1, wherein the prepolymers of the output stream from step e) consist essentially of hydroxy-terminated prepolymers.

16. The process as claimed in claim 1, wherein at least process steps b), c), d) and e) are performed in a loop reactor.

17. The process as claimed in claim 16, wherein the loop reactor has a pressure control means and the pressure is set in the range from 2 bar absolute to 11 bar absolute and/or wherein the viscosity of the material stream in the loop reactor is below 10 Pa·s at a measurement temperature of 190° C. and a frequency of 10 Hz, determined in accordance with ISO 6721-10:2015.

18. (canceled)

19. The process as claimed in claim 16, wherein the loop reactor has at least one heat exchanger having a heat-transfer capacity, based on the total volume of the loop reactor, of more than 10 kW/(m³·K).

20. The process as claimed in claim 19, wherein the loop reactor has at least one heat exchanger and the ratio of heat-transfer surface area to loop reactor surface area is >0.3 and/or wherein the heat-transfer surface area in the reactor has an average k value of >50 W/(m²·K).

21. (canceled)

22. The process as claimed in claim 1, wherein the thermoplastic polyurethane is essentially formed by polyaddition of combinations of component (A) and component (B) selected from the group consisting of 1,4-diisocyanatobutane with ethane-1,2-diol, 1,4-diisocyanatobutane with propane-1,2-diol and/or -1,3-diol, 1,4-diisocyanatobutane with butane-1,2-diol, -1,3-diol and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2-diol and/or -1,3-diol, 1,5-diisocyanatopentane with butane-1,2-diol, -1,3-diol and/or -1,4-diol, 1,5-diisocyanatopentane with pentane-1,5-diol, 1,5-diisocyanatopentane with hexane-1,6-diol, 1,6-diisocyanatohexane with ethane-1,2-diol, 1,6-diisocyanatohexane with propane-1,2-diol and/or -1,3-diol, 1,6-diisocyanatohexane with butane-1,2-diol, -1,3-diol and/or -1,4-diol, 1,6-diisocyanatohexane with pentane-1,5-diol and 1,6-diisocyanatohexane with hexane-1,6-diol.

23. A thermoplastic polyurethane obtained by the process as claimed in claim 1.
